(19) United States
(12) Patent Application Publication
(10) Pub. No.: US 2023/0167933 A1
(43) Pub. Date: Jun. 1, 2023

(54) INTEGRATED MANIFOLD AND SWITCHES FOR FLUIDIC MOVEMENT

(71) Applicant: Applied Materials, Inc., Santa Clara, CA (US)

(72) Inventor: Joseph R. Johnson, Redwood City, CA (US)

(73) Assignee: Applied Materials, Inc., Santa Clara, CA (US)

(21) Appl. No.: 17/538,407

(22) Filed: Nov. 30, 2021

(51) Int. Cl. F16L 41/03; B01L 3/00

(52) U.S. Cl. CPC F16L 41/03; B01L 3/502715; B01L 2200/027; B01L 2200/0647; B01L 2200/16; B01L 2300/0867; B01L 2300/0877; B01L 2400/0633

(57) ABSTRACT

Exemplary spatial genomics systems may include a flow cell and a fluid manifold. The flow cell may define an open interior, a fluid inlet to a first end of the open interior, and a fluid outlet to a second end of the open interior opposite the first end. The fluid manifold may include a body defining a plurality of fluid inlet lumens, a fluid outlet lumen, and a fluid waste lumen. Each of the plurality of fluid inlet lumens may be fluidly coupled with the fluid outlet lumen. The fluid outlet lumen may be fluidly coupled with the flow cell. The fluid manifold may include a plurality of fluid switches. Each of the plurality of fluid switches may be fluidly coupled with a respective one of the plurality of fluid inlet lumens. The fluid waste lumen may be fluidly coupled with the fluid outlet of the flow cell.

### TECHNICAL FIELD

The present technology relates to components and apparatuses for biological imaging. More specifically, the present technology relates to fluid manifolds that control the flow of reagents in biological imaging systems.

### BACKGROUND OF THE INVENTION

Biological imaging techniques, and particularly those for imaging mRNA, require significant amounts of time to prepare and image the samples. In some instances, the entire process may span multiple days. Some techniques may require the mRNA to be extracted and/or otherwise dissociated from the tissue prior to imaging, which may introduce additional complex and time consuming steps. A number of different reagents may be used to image various characteristics and/or features of a tissue sample. Oftentimes, a reagent manifold is coupled with a switch assembly to control the flow of the various reagents. Conventionally, the manifolds and switch assemblies have been located remotely from one another, which necessitates the use of long tubes to fluidly couple the devices to deliver reagents to a flow cell. This long tubing length causes numerous problems, such as unnecessary waste of reagents and slow pumping times.

Thus, there is a need for simple fluid manifold designs and components that can be used to deliver reagents and other fluids to flow cells in a more efficient manner. These and other needs are addressed by the present technology.

### BRIEF SUMMARY OF THE INVENTION

Exemplary spatial genomics system may include a flow cell and a fluid manifold. The flow cell may define an open interior, a fluid inlet in fluid communication with a first end of the open interior, and a fluid outlet that is in fluid communication with a second end of the open interior opposite the first end. The fluid manifold may include a body defining a plurality of fluid inlet lumens, a fluid outlet lumen, and a fluid waste lumen. Each of the plurality of fluid inlet lumens may be fluidly coupled with the fluid outlet lumen. The fluid outlet lumen may be fluidly coupled with the fluid inlet of the flow cell. The fluid manifold may include a plurality of fluid switches. Each of the plurality of fluid switches may be fluidly coupled with a respective one of the plurality of fluid inlet lumens. The fluid waste lumen may be fluidly coupled with the fluid outlet of the flow cell.

In some embodiments, the body of the fluid manifold may include a first body portion defining at least a portion of each of the plurality of fluid inlet lumens and a second body portion that is interfaced with each of the plurality of fluid switches. Each of the plurality of fluid inlet lumens may include a section that is formed by a groove defined in a surface of the first body portion that faces the second body portion. A first fluid delivery conduit may extend between and couples the fluid outlet lumen of the fluid manifold and the fluid inlet of the flow cell. A second fluid delivery conduit may extend between and couples fluid outlet of the flow cell and the fluid waste lumen. The spatial genomics system may include a plurality of fluid lines. Each fluid line may include an outlet that is fluidly coupled with a respective fluid source and one of the plurality of fluid inlet lumens. A medial portion of each of the plurality of fluid inlet lumens may define a fluid outlet port and a fluid inlet port. Each of the plurality of fluid switches may include a switch inlet that is interfaced with a respective one of the fluid outlet ports, a switch outlet that is interfaced with a respective one of the fluid inlet ports, and a valve that is movable between an open position and a closed position to control flow through the fluid switch. Each of the switch inlets may be in vertical alignment with a respective outlet of one of the plurality of fluid lines. The body of the fluid manifold may define a buffer fluid lumen upstream and in fluid communication with the fluid outlet lumen. The fluid manifold may include a waste reservoir coupled with an outlet end of the fluid waste lumen.

Some embodiments of the present technology may encompass fluid manifolds. The fluid manifolds may include a body. The body may define a plurality of fluid inlet lumens, a fluid outlet lumen, and a fluid waste lumen. Each of the plurality of fluid inlet lumens may be fluidly coupled with the fluid outlet lumen. The fluid outlet lumen may include an outlet interface. A fluid manifold may include a plurality of fluid switches. Each of the plurality of fluid switches may be fluidly coupled with a respective one of the plurality of fluid inlet lumens.

In some embodiments, each of the plurality of fluid inlet lumens may include a first portion that is coupled with a switch inlet of one of the plurality of fluid switches and a second portion that is coupled with a switch outlet of the one of the plurality of fluid switches. The body of the fluid manifold may define a buffer fluid lumen upstream of and in fluid communication with the fluid outlet lumen. The fluid manifold may include a buffer fluid switch that is operable to control a flow of buffer fluid through the buffer fluid lumen. Each of the plurality of fluid switches may include a microfluidic flow switch. Each of the plurality of fluid inlet lumens may include a chemical inlet. A portion of each fluid inlet lumen that is upstream of a respective one of the plurality of fluid switches may be fluidly isolated from others of the plurality of fluid inlet lumens.

Some embodiments of the present technology may encompass semiconductor processing methods. The methods may include flowing a plurality of chemicals to a plurality of chemical inlets of a fluid manifold. The fluid manifold may include a plurality of fluid switches in fluid communication with the plurality of chemical inlets. The methods may include actuating one of the plurality of fluid switches to permit one of the plurality of chemicals into a fluid outlet lumen. The methods may include flowing the one of the plurality of chemicals into the flow cell.

In some embodiments, the methods may include, subsequent to flowing the one of plurality of chemicals into the flow cell, flowing a buffer solution to the fluid outlet lumen. The methods may include flowing the buffer solution into the flow cell. The methods may include flowing fluid out of the flow cell to a waste reservoir using a waste lumen defined in the fluid manifold. Flowing the one of plurality of chemicals into the flow cell may include flowing the one of plurality of chemicals through a fluid delivery conduit between the fluid manifold and the flow cell. A length of the fluid delivery conduit may be less than or about 2.0 m. The methods may include sequentially delivering individual chemicals of the plurality of chemicals through respective ones of the fluid switches into the fluid outlet lumen, followed by delivering a buffer solution to the fluid outlet lumen between delivery of each individual chemical of the plurality of chemicals.

Such technology may provide numerous benefits over conventional systems and techniques. For example, embodiments of the present technology may include fluid manifolds that integrate fluid switches for selectively controlling the flow of reagents and other fluids to flow cells for imaging tissue samples. Such manifolds may reduce the length of fluid tubing required by spatial genomics systems, and may help reduce fluid pumping times and fluid waste. These and other embodiments, along with many of their advantages and features, are described in more detail in conjunction with the below description and attached figures.

### BRIEF DESCRIPTION OF THE DRAWINGS

A further understanding of the nature and advantages of the disclosed technology may be realized by reference to the remaining portions of the specification and the drawings.

FIG. 1A shows a schematic view of an exemplary spatial genomics system according to some embodiments of the present technology.

FIG. 1B shows a schematic view of an exemplary flow cell according to some embodiments of the present technology.

FIG. 2A shows an isometric view of an exemplary fluid manifold according to some embodiments of the present technology.

FIG. 2B shows an exploded isometric view of an exemplary fluid manifold according to some embodiments of the present technology.

FIG. 2C shows an isometric view of an exemplary spatial genomics system having a fluid manifold integrated with a switching unit according to some embodiments of the present technology.

FIG. 3A shows a partial cross-sectional view of an exemplary fluid manifold with a switch in the closed position according to some embodiments of the present technology.

FIG. 3B shows a partial cross-sectional view of an exemplary fluid manifold with a switch in the open position according to some embodiments of the present technology.

FIG. 4 shows operations of an exemplary method of supplying a chemical to a flow cell according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION OF THE INVENTION

Spatial genomic imaging techniques may utilize flow-cells that enable reagents to be introduced to tissue samples for imaging of mRNA species. The reagents may be delivered from a supply unit, such as a manifold. Conventional spatial genomic imaging systems may require individual reagents to be flowed from the supply unit through a separate switching unit that selectively supplies reagents to the flow cell. Tubing may be used to couple the supply unit, switching unit, and flow cell. In existing spatial genomic imaging system designs, there may be considerable distance between the various components, which may necessitate the use of lengthy fluid tubing. In some systems this distance may be further increased to facilitate servicing of the switching unit. For example, the supply unit may be slidable (such as being positioned on rails) to enable the supply unit to be moved away from the switching unit to provide access to individual components of the switching unit. The use of longer tubing increases the time needed to pump reagents and other fluids from the supply unit to the flow cell. The increased length of fluid tubing may increase pumping times, which leads to increased execution times of each imaging operation. In some instances, the pumping times may span multiple hours and may make up over 50% of the run time for a particular imaging operation. This may significantly limit the number of imaging operations a user is capable of completing during a given time period. Additionally, the long lengths of tubing may lead to leaks and/or other issues that may result in poor imaging of the tissue sample and/or poor operation of the spatial genomic imaging system. Additionally, the lengths of tubing may require greater volumes of reagents to be used in imaging procedures, which may increase waste and/or result in the reagents becoming stagnant in the tubing.

The present technology overcomes these challenges by utilizing supply unit designs that include fewer components that are quick and easy to assemble. In particular, the supply units integrate a fluid manifold and switching unit into a single component that may significantly reduce the length of tubing needed to couple fluid lines with the switches. In some instances, the length of tubing utilized may be reduced by approximately 50%, which may significantly reduce pumping times and increase the efficiency of tissue imaging operations. Additionally, the reduction in tubing length may reduce the volume of reagent and other fluids that are used by the imaging system for each imaging procedure. Accordingly, the present technology may enable more efficient delivery of reagents and other fluids to flow cells and may increase the speed and efficiency of tissue imaging operations.

Although the remaining disclosure will routinely identify specific fluid manifolds utilizing the disclosed technology, it will be readily understood that the systems and methods are equally applicable to other fluid delivery units. Accordingly, the technology should not be considered to be so limited as for use with these specific supply units. The disclosure will discuss several possible supply unit, or fluid manifold, designs according to embodiments of the present technology before additional variations and adjustments to this system according to embodiments of the present technology are described.

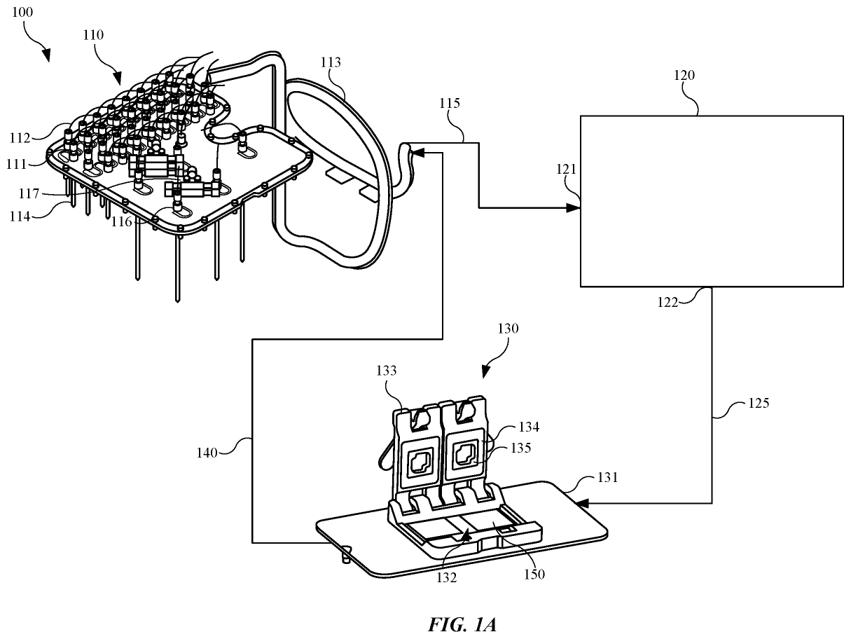

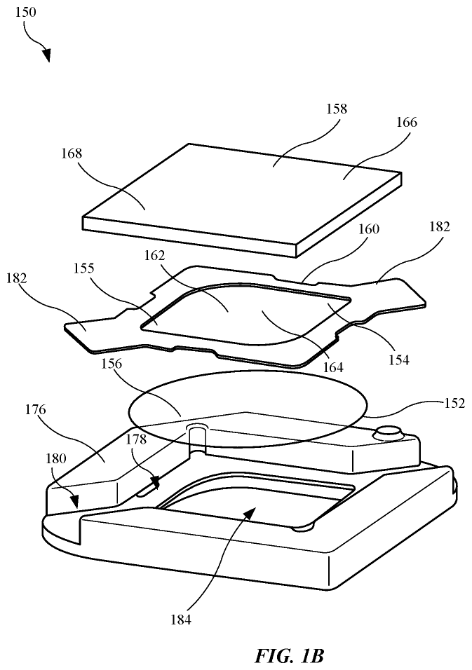

FIG. 1 illustrates an exemplary spatial genomic system 100. The spatial genomic system 100 may include a fluid manifold 110, a switching unit 120, and a mechanical clamp 130 for holding a flow cell 150. The spatial genomic system 100 may be used to image biological tissue samples, such as for imaging mRNA. To facilitate such imaging procedures, the fluid manifold 110 may supply a number of reagents, buffer agents, bleaching agents, and/or other fluids to the flow cell 150. The switching unit 120 may be used to selectively control the delivery of the fluids to the flow cell 150, and to control removal of the fluids from the flow cell 150 after a given imaging operation and/or rinsing of the fluid lines and/or tissue sample.

Reagents and/or other fluids (such as bleaching agents, buffer agents, etc.) may be introduced into the spatial genomic system 100 via a plurality of fluid inlets 111 defined by the fluid manifold 110. Each fluid inlet 111 may be in fluid communication with a respective one of a plurality of fluid sources (not shown) via a plurality of fluid lines 114. Each fluid line 114 may include an inlet that is fluidly coupled with a respective fluid source and an outlet that is fluidly coupled with one of the plurality of first fluid inlet lumens 112. Each of the fluid inlets 111 may be in fluid communication with a first fluid lumen 112. Thus, the fluid manifold 110 may include a plurality of first fluid lumens 112 that are each in fluid communication with a respective fluid inlet 111. The first fluid lumen 112 may deliver the reagents and/or other fluids from the fluid manifold 110 to the switching unit 120. A length of the first fluid lumens 112 may be greater than or about 1.5 meters. In some embodiments, the plurality of first fluid lumens 112 may be bundled to form a large coil 113.

The fluid manifold 110 may also include a waste outlet 116. The waste outlet 116 may be in fluid communication with the flow cell 150, such as an outlet of the flow cell 150. The waste outlet 116 may be operable to store any process waste in a waste reservoir (not shown) in fluid communication with the waste outlet 116. The waste outlet 116 may be in fluid communication with a waste lumen 117. The waste lumen 117 may be disposed in the large coil 113 along with the plurality of first fluid lumens 112 in some embodiments. The waste outlet 116 may be in fluid communication with the flow cell via a delivery conduit 140.

The switching unit 120 may be disposed downstream of the fluid manifold 110. The switching unit 120 may include a plurality of fluid switches (not shown). The switching unit 120 may include a switching unit inlet 121 in fluid communication with the second fluid lumen 113. Depending on the desired imaging operation in the flow cell 150, the fluid manifold 110, in combination with the switching unit 120, may direct specific reagents and/or other fluids to the flow cell 150. In embodiments, the switching unit 120 may include a plurality of microfluidic flow switches. The switching unit 120 may include at least as many fluid switches as fluid inlets 111 defined in the fluid manifold 110. A switching unit outlet 122 may be in fluid communication with the flow cell via a delivery conduit 125. Delivery conduit 125 may include greater than or about 2.0 meters of tubing.

One or more flow cells 150 may be provided that may be supported by a mechanical clamp 130. For example, the mechanical clamp 130 may be operable to receive and isolate each flow cell 150, which is described below, during imaging. The mechanical clamp 130 may include a drip tray 131 that may receive the assembled flow cell 150. The drip tray 131 may define a pocket 132 in which the flow cell 150 may be placed. The pocket 132 may include a recessed area that is sized to receive the flow cell 150. The pocket 132 may define a position and height of the flow cell 150 within an imaging device. Pocket 132 may also define an aperture therethrough that enables a backside of the flow cell 150 to be illuminated and/or imaged. While illustrated as being able to support two flow cells 150 side-by-side, it will be appreciated that the drip tray 131 (and the rest of the mechanical clamp 130) may be sized to receive any number of flow cells 150. For example, the mechanical clamp 130 may receive at least or about 1 flow cell, at least or about 2 flow cells, at least or about 3 flow cells, at least or about 4 flow cells, or more.

Mechanical clamp 130 may also include a lid 133 that is pivotable relative to the drip tray 131 (and the rest of flow cell 150) to compress the flow cell 150. For example, the lid 133 may be pivotally coupled with the drip tray 131. In embodiments where the drip tray 131 supports multiple flow cells 150, each flow cell 150 may have an independently pivotable lid 133 (as shown here) or multiple of the flow cells 150 may share a common lid 133. For each flow cell 150 covered, a given lid 133 may include a pressure plate 134 that may be sized and shaped to engage with a top surface of a given flow cell 150. For example, each pressure plate 134 may include a central region that may press against a top surface of the flow cell to compress the flow cell, thereby sealing the flow cell. The pressure plate 134 may include ports 135 that may align with a fluid inlet and fluid outlet of the flow cell 150 when the lid 133 is closed to enable a fluid source to be coupled with the fluid inlet and fluid outlet of the flow cell 150. A sealing member, such as an O-ring, may be fitted about each of the ports 135 to help seal the interface between the port 135 and the respective one of the fluid inlet and fluid outlet.

Referring to FIG. 1B, an exploded view of an exemplary flow cell 150 according to some embodiments of the present technology is depicted. It should be noted that flow cell 150 is an exemplary flow cell and that any other suitable flow cell may be used with the mechanical clamp 130 or any other flow cell holding mechanism.

Flow cell 150 may include a coverslip 152 having a top surface 156 that may be used to support a tissue sample. A gasket 160 may be positioned atop the coverslip 152. The gasket 160 may be formed from a biocompatible material, such as silicone. The gasket 160 may define an open interior that may serve as a fluid region 162 for the flow cell 150. The gasket 160 may be sized and shaped such that a width of the fluid region 162 is greater within a medial portion of the fluid region 162 than near a first end 154 and a second end 155. As noted above, such a design of the fluid region 162 may enable flow through the fluid region 162 to be generally uniform and at a sufficiently slow rate so as to uniformly expose the tissue sample to fluid while also ensuring that the force of the flowing fluid does not displace the tissue sample from the top surface 156 of the coverslip 152. As illustrated, the open interior of the gasket 160 may be generally diamond-shaped, with a medial region 164 of the fluid region 162 being wider than ends 154 and 155 of the fluid region 162, although it will be appreciated that other shapes that deliver the desired flow characteristics (e.g., generally uniform distribution of fluid and desired flow rate) may be utilized in various embodiments. In some embodiments, the internal corners of the fluid region 162 may be rounded so as to prevent eddies and/or other turbulent flow from occurring within the fluid region 162.

The flow cell 150 may include a top plate 158 which may be positionable atop the coverslip 152 and gasket 160. The top plate 158 may be formed of an optically transparent material, such as a glass or plastic, which may enable the tissue sample to be illuminated and/or imaged through the top plate 158. To enable the flowing of fluids through the fluid region 162, the top plate 158 may define a fluid inlet 166 and a fluid outlet 168. When the top plate 158 is positioned over the gasket 160 and the coverslip 152, the fluid inlet 166 may be aligned with the first end 154 of the fluid region 162 and the fluid outlet 168 may be aligned with the second end 155 of the fluid region 162. This may enable a fluid source (not shown) to be interfaced with the fluid inlet 166 to deliver one or more reagents and/or other fluids to the fluid region 162. When positioned atop the coverslip 152 and gasket 160, a portion of a bottom surface of the top plate 158 may form a top boundary of the fluid region 162, while a portion of the top surface 156 of the coverslip 152 forms a bottom boundary of the fluid region 162 and the gasket 160 forms a lateral boundary of the fluid region 162. The fluid region 162 may have a height of between or about 30 microns and 500 microns, between or about 50 microns and 400 microns, between or about 75 microns and 300 microns, or between or about 100 microns and 200 microns. Such heights (along with the shape and/or width of the fluid region 162) may help maintain fluid flow rates within the fluid region 162 of between about 0.1 mL/min and 3 mL/min for low viscosity fluids (e.g., between or about 0.5 cP and 5 cP) and of 100 μL/min and 1 mL/min for high viscosity fluids (e.g., above or about 5 cP), which may help ensure that the forces from the fluid flowing through the fluid region 162 (and in particular at the portion of the fluid region 162 in which the tissue sample is disposed) are sufficiently low so as to prevent the fluid from damaging or displacing the tissue sample.

Flow cell 150 may include a bottom plate 176 that may be positioned beneath the coverslip 152. The bottom plate 176 may receive and align the top plate 158, gasket 160, and coverslip 152 to ensure that the fluid inlet 166 and fluid outlet 168 are properly aligned with the ends of the fluid region 162. The bottom plate 176 may also serve as a substrate that enables the flow cell 150 components to be assembled and transported. For example, the bottom plate 176 may define a central recess 178 that receives the coverslip 152, the gasket 160, and the top plate 158. In some embodiments, the central recess 178 may be sized and shaped to help align the various components received therein. For example, a size and shape of the central recess 178 may substantially match outer shapes of one or more of the top plate 158, gasket 160, and the coverslip 152. As illustrated, portions of the outer peripheries of the top plate 158 and gasket 160 have generally rectangular shapes that may closely match (e.g., within or about 10%, within or about 5%, within or about 3%, within or about 1%, or less) dimensions of the central recess 178 to ensure that the components are aligned when inserted into the central recess 178. To further assist with proper alignment of the components, the central recess 178 may include at least one alignment feature that ensures that the coverslip 152, gasket 160, and/or top plate 158 are properly oriented within the central recess 178. For example, as illustrated, two opposing corners of the central recess 178 include notches 180 that extend outward from the central recess 178. One or more of the components received within the central recess 178 may include protrusions that are sized and shaped to fit within the notches 180. For example, in the illustrated embodiment the gasket 160 includes protrusions 182 that are positioned at opposite ends of the gasket 160. The protrusions 182 may be inserted within the notches 180 to properly orient the gasket 160 within the central recess 178. While shown with two notches 180 and/or protrusions 182, it will be appreciated that any number of such alignment features and/or other alignment features may be included on the bottom plate 176 and/or one or more of the components received therein.

In some embodiments, the bottom plate 176 may define a central aperture 184, which may extend through all or a portion of the central recess 178. Central aperture 184 may enable a backside of the flow cell 150 to be illuminated and/or imaged.

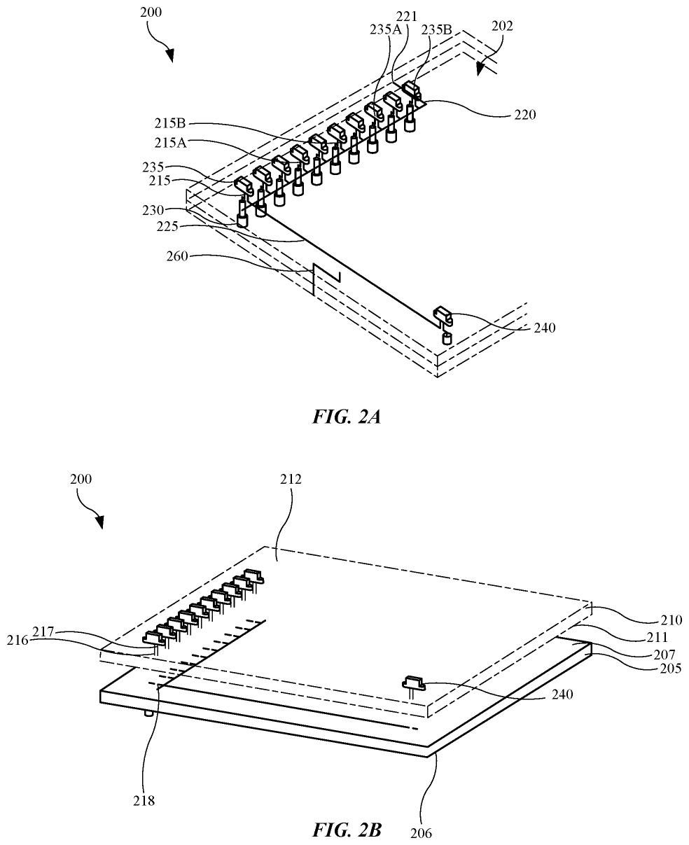

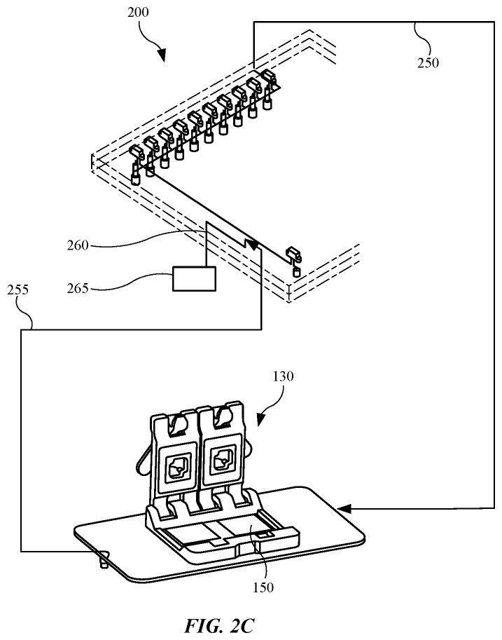

FIGS. 2A and 2B illustrate an exemplary fluid manifold 200 according to some embodiments of the present technology. FIGS. 2A and 2B may include one or more components discussed above with regard to FIG. 1, and may illustrate further details relating to that fluid manifold and/or switching unit. Fluid manifold 200 may include any feature or aspect of fluid manifold 110 discussed previously. Fluid manifold 200 may include a body 202. The body 202 may be characterized by any shape such as, for example, cylindrical, conical, cubical, spherical, or any other three-dimensional prism shape.

The body 202 may include a first body portion 205 and a second body portion 210. The first body portion 205 and the second body portion 210 may be characterized by the same shape and size or, alternatively, may be a different shape and/or size. The first body portion 205 may be characterized by an upper surface 207 and a lower surface 206. The second body portion 210 may be characterized by an upper surface 212 and a lower surface 211. The first body portion 205 may be in alignment, such as vertical alignment or horizontal alignment, with the second body portion 210. The first body portion 205 and the second body portion 210 may alternatively be staggered such that the body portions 205, 210 are not in vertical or horizontal alignment. In alternative embodiments, the body 202 may be a unitary piece with any necessary components, as described below, bored and/or otherwise into the single body 202.

The body 202 may define a plurality of fluid inlet lumens 215, a fluid outlet lumen 220, and a fluid waste lumen 260. A first portion 216 of the plurality of fluid inlet lumens 215 may be partially and/or fully defined in the first body portion 205 and partially and/or fully defined in the second body portion 210. For example, the first portion 216 may be a lumen that extends vertically through a thickness of the first body portion 205 (such as from the lower surface 206 through the upper surface 207) and/or a lumen that extends through a thickness of the second body portion 210 (such as from the lower surface 211 through the upper surface 212). As illustrated, the first portion 216 extends through the thickness of both the first body portion 205 and the second body portion 210 such that a lumen extends from lower surface 206 through upper surface 212. Each of the plurality of fluid inlet lumens 215, such as the first portions 216, may include and/or be in fluid communication with a chemical inlet 230. The chemical inlet 230 may be defined in and/or coupled with the body 202. As shown in the embodiment of FIGS. 2A-2B, each of the plurality of chemical inlets 230 may be defined in the lower surface 206 of the first body portion 205.

A second portion 217 of the plurality of fluid inlet lumens 215 may be defined in the second body portion 210. For example, the second portion 217 may be in the form of a lumen that extends through a thickness of the second body portion 210 (such as from the lower surface 211 through the upper surface 212). In some embodiments, the first portion 216 and second portion 217 may be parallel and/or in close proximity to one another.

A third portion 218 of the plurality of fluid inlet lumens 215 may be defined in the first body portion 205, the second body portion 210, or a combination of both. For example, the upper surface 207 of the first body portion 205 and/or the lower surface 211 of the second body portion 210 may define a groove that partially defines a periphery of the third portion 218. When the first body portion 205 and second body portion 210 are coupled (oftentimes with a gasket, O-ring, and/or other sealing mechanism disposed therebetween), open surfaces of the groove(s) may be closed off by the opposing body portion to produce a lumen having a periphery that is fully bound. In other embodiments, the first body portion 205 and/or second body portion 210 may define a bore and/or lumen that may fully define the third portion 218. The third portion 218 may be at least substantially orthogonal to the first portion 216 and/or the second portion 217.

The first portion 216 may be in fluid communication with the second portion 217 via a fluid switch 335 as will be discussed in greater detail below. The second portion 217 may be in fluid communication with the third portion 218. For example, an outlet end of the second portion 217 may intersect an inlet end of the third portion 218. The third portion 218 may be fluidly coupled with a fluid outlet lumen 220 that may be defined within the body 202. For example, the fluid outlet lumen 220 may be defined in the first body portion 205, the second body portion 210, or a combination of both. In embodiments, the fluid outlet lumen 220 may be defined in the upper surface 207 of the first body portion 205 or the lower surface 211 of the second body portion 210. For example, the upper surface 207 of the first body portion 205 and/or the lower surface 211 of the second body portion 210 may define a groove that forms the fluid outlet lumen 220 when the first body portion 205 and second body portion 210 are joined. In other embodiments, the first body portion 205 and/or second body portion 210 may define a bore and/or lumen that may fully define the fluid outlet lumen 220. The fluid outlet lumen 220 may include and be in fluid communication with an outlet interface 221, or a fluid outlet defined in the body. The coupling of the first portion 216, second portion 217, third portion 218, and fluid outlet lumen 220 as described above may provide fluid paths that enable different reagents and/or other fluids introduced into the fluid manifold 200 via the chemical inlets 230 to be selectively flowed to a flow cell (such as flow cell 150) via a single delivery conduit (such as delivery conduit 250 as described in relation to FIG. 2C). For example, an inlet end of the delivery conduit may be coupled with the fluid manifold 200 via the outlet interface 221, while an outlet end of the delivery conduit may be coupled with a fluid inlet of the flow cell. As shown in the embodiment of FIGS. 2A-2B, the outlet interface 221 may be defined in a side surface of the first body portion 205, the second body portion 210, or a combination of both. In other embodiments, the outlet interface 221 may be defined in upper surface 212 and/or lower surface 206. The fluid outlet lumen 220 may be defined in the same portion of the body 202 as the third portion 218.

The upper surface 207 of the first body portion 205 and/or the lower surface 211 of the second body portion 210 may define a groove that partially defines a periphery of the fluid waste lumen 260. When the first body portion 205 and second body portion 210 are coupled (again, oftentimes with a gasket, O-ring, and/or other sealing mechanism disposed therebetween), open surfaces of the groove(s) may be closed off by the opposing body portion to produce a lumen having a periphery that is fully bound. In other embodiments, the first body portion 205 and/or second body portion 210 may define a bore and/or lumen that may fully define the fluid waste lumen 260. The fluid waste lumen 260 may be at least substantially parallel to the third portion 218.

As noted above, the fluid manifold 200 may also include a plurality of fluid switches 235. Each of the plurality of fluid switches 235 may be fluidly coupled with a respective one of the plurality of fluid inlet lumens 215. The plurality of fluid switches 235 may be disposed between the first portion 216 and the second portion 217 to control the flow of fluids into the second portion 217, and subsequently the fluid outlet lumen 220. As shown in the embodiment of FIGS. 2A-2B, the plurality of fluid switches 235 may be disposed on the upper surface 212 of the second body portion 210. A medial portion of each of the plurality of fluid inlet lumens 215 may define a fluid outlet port 215A and a fluid inlet port 215B. For example, the first portion 216 of each fluid inlet lumen 215 may define a fluid outlet port 215A and the second portion 217 of each fluid inlet lumen 215 may define a fluid inlet port 215B. Each of the plurality of fluid switches 235 may include a switch inlet 235A that is interfaced with a respective one of the fluid outlet ports 215A. Each of the plurality of fluid switches 235 may include a switch outlet 235B that is interfaced with a respective one of the fluid inlet ports 215B. Each of the plurality of fluid switches 235 may include a valve (not shown) that is movable between an open position and a closed position to control flow through the fluid switch 235. Each of the switch inlets 235A may be in vertical alignment with a respective outlet of a fluid line (such as first fluid lumen 112) and/or chemical inlet 230.

The plurality of fluid switches 235 may prevent fluid, such as reagents, being provided to the fluid manifold 200 from being flowed to the fluid outlet lumen 220 until a respective fluid switch 235 is opened. As a fluid is needed to be flowed to the fluid outlet lumen 220, the respective fluid switch 235 associated with the fluid inlet lumen 215 may enable the fluid to flow from the fluid inlet lumen 215 to the fluid outlet lumen 220, such as via second portion 217 and third portion 218 of the fluid inlet lumen 215. A portion of each fluid inlet lumen 215 that is upstream of a respective one of the plurality of fluid switches 235 may be fluidly isolated from others of the plurality of fluid inlet lumens 215 by a respective fluid switch 235. For example, when a given fluid switch 235 is closed, the first portion 216 of the associated fluid inlet lumen 215 may be closed off and/or otherwise isolated from the fluid outlet lumen 220 and the other fluid inlet lumens 215. This may help prevent any backstreaming of fluids from one fluid inlet lumen 215 to another fluid inlet lumen 215 and/or back into a different fluid source.

The plurality of fluid switches 235 may be any switch or valve operable to control the flow of fluid. In embodiments, each of the plurality of fluid switches 235 may be a microfluidic flow switch. The plurality of fluid inlet lumens 215, the fluid outlet lumen 220, or both may be pressurized to force any fluid, or reagent, in the lumens out of the body of the fluid manifold 200. For example, the fluids may be pumped and/or otherwise delivered to the fluid inlet lumens 215 with a positive pressure that may propel the fluid downstream through the fluid manifold 200. Thus, after one of the fluid switches 235 is opened, the fluid, or reagent, in the respective fluid inlet lumen 215 may be forced out of the body of the fluid manifold 200 via the second portion 217 and third portion 218 of the respective fluid inlet lumen 215, at least a portion of the fluid outlet lumen 220, and through the outlet interface 221, or the fluid outlet defined in the body 202.

The body of the fluid manifold 200 may define a buffer fluid lumen 225. The buffer fluid lumen 225 may be upstream of and in fluid communication with the fluid outlet lumen 220. The buffer fluid lumen 225 may be used to flow a buffer solution and/or other rinsing agent through the buffer fluid lumen 225 and the fluid outlet lumen 220 to purge any fluid remaining in the fluid outlet lumen 220 and/or the flow cell. The fluid manifold 200 may also include a buffer fluid switch 240 that is operable to control a flow of buffer fluid through the buffer fluid lumen 225. The buffer fluid switch 240 may have any of the same properties as the plurality of fluid switches 235. For example, the buffer fluid switch 240 may include a switch inlet that is fluidly coupled with a buffer fluid source. The buffer fluid switch 240 may include a switch outlet that is fluidly coupled with a downstream portion of the buffer fluid lumen 225. The buffer fluid switch 240 may include a valve that may be selectively opened to enable buffer fluid to flow through the buffer fluid lumen 225, fluid outlet lumen 220, outlet interface 221, and the flow cell.

While the lumens in the fluid manifold 200 may be pressurized, some backflow may inevitably occur. More specifically, as the fluid outlet lumen 220 includes a plurality of fluid inlet lumens 215 in fluid communication with the fluid outlet lumen 220, when a fluid is flowed through a fluid inlet lumen 215 that is further downstream on the fluid outlet lumen 220, some fluid may backflow in the fluid outlet lumen 220. However, as the lumens may be pressurized, this backflow may be minimal. Additionally, the presence of the fluid switches 235 in each fluid inlet lumen 215 may help prevent any backflow from reaching a different fluid source as described above. Further, the buffer fluid lumen 225 may be able to flush any inadvertent backflow out of the fluid outlet lumen 220. In some embodiments, it is contemplated that additional valves or switches may be included in the fluid outlet lumen 220 upstream of each of the plurality of fluid inlet lumens 215 to reduce or prevent backflow. For example, a valve and/or switch may be included proximate the junction between the third portion 218 and the fluid outlet lumen 220 (upstream and/or downstream of the third portion 218) that may be selectively opened and closed to permit fluid to flow along the desired flow path while preventing any undesired backstreaming.

Each of the lumens may have inner diameters that may be dictated by the diameters of the fluid switches 235. For example, the inner diameters of the lumens may be from about 0.01 inch to about 0.05 inch. However, based on the fluid switch 235 employed, the inner diameters of the lumens may vary. Further, the inner diameters of the lumens may not be constant throughout the fluid manifold 200. Additionally, or alternatively, the diameters of all or part of the lumens may be dictated by other factors, such as the size of chemical inlets 230, a desired flow rate within the lumen, a desired pressure within the lumen, a viscosity of the fluid(s) being flowed through the lumen, and/or other variables.

Conventional systems may use a switching unit that is separate from the fluid manifold. This separation requires long lengths of tubing between the separate components. In conventional systems, tubing may be present between the fluid manifold, the switching unit, and the flow cell. In embodiments of the present disclosure, by integrating the fluid switches with the fluid manifold, the length of tubing between the conventional fluid manifold and switching unit may be significantly reduced and/or eliminated. This reduction in tubing in the system may drastically reduce pumping times, which may increase throughput and efficiency in the system. By reducing the length of tubing, fluids, or reagents, and the need to travel a shorter distance, the volume of fluid utilized by the imaging system in a given imaging operation may be reduced, as priming the lines may be done using a lesser volume of fluid.

As shown in FIG. 2C, in embodiments of the present disclosure, where the fluid manifold 110 and the switching unit 120 of FIG. 1 are replaced with the fluid manifold 200 described above, a first fluid delivery conduit 250 may extend between and couple the fluid outlet lumen 220 of the fluid manifold 200 and a fluid inlet of the flow cell 150. A second fluid delivery conduit 255 may extend between and couple a fluid outlet of the flow cell 150 and a fluid waste lumen 260. The fluid waste lumen 260 may be in fluid communication with a waste reservoir 265 for storing waste fluid. The lengths of the first fluid delivery conduit 250 and the second fluid delivery conduit 255 may be less than or about 2.0 m, such as less than or about 1.8 m, less than or about 1.6 m, less than or about 1.4 m, less than or about 1.2 m, less than or about 1.0 m, less than or about 0.8 m, less than or about 0.6 m, less than or about 0.4 m, or less. The reduced lengths relative to conventional systems may be attributed to the integration of the switching unit into the fluid manifold 200. Additionally, as the components are integrated into a single unit, a sliding distance may be reduced and/or there may be no need to allow the fluid manifold 200 to slide on rails (or other mechanism) to facilitate servicing of a separate switching unit. This may further enable the delivery conduits to be shortened.

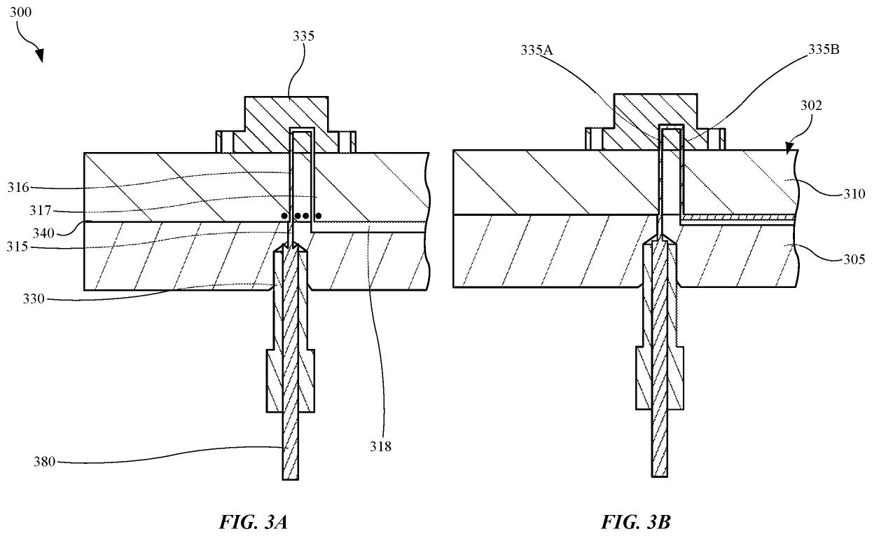

FIGS. 3A-3B illustrate a partial cross-sectional view of a fluid manifold 300. FIGS. 3A-3B may include one or more components discussed above with regard to FIGS. 1 and 2A-2B, and may illustrate further details relating to that fluid manifold. FIG. 3A illustrates a fluid switch 335 (which may be similar to and include any of the feature of fluid switch 235) in a closed position that prevents fluid from passing downstream of the fluid switch 335. FIG. 3B illustrates the fluid switch 335 in an open position that permits fluid to flow downstream of the fluid switch 335. Fluid manifold 300 may include any feature or aspect of fluid manifold 110 or 200 discussed previously.

As shown in FIGS. 3A-3B, and as previously discussed, the fluid manifold 300 may include a body 302, which may include a first body portion 305 and a second body portion 310. The first body portion 305 may be in alignment, such as vertical alignment or horizontal alignment, with the second body portion 310. The body 302 may define a plurality of fluid inlet lumens 315, with each of the fluid inlet lumens 315 being fluidly coupled with a respective fluid switch 335. The plurality of fluid inlet lumens 315 may be in fluid communication with a fluid outlet lumen (not shown).

Each of the plurality of fluid inlet lumens 315 may include and/or otherwise be in fluid communication with a chemical inlet 330. For example, a first portion 316 of each fluid inlet lumen 315 may define and/or include a respective one of the chemical inlets 330. The chemical inlet 330 may be coupled with and/or defined in the body, such as the first body portion 305. The chemical inlet 330 may receive a fluid line 380, which may be fluidly coupled between a fluid source (not shown) and the fluid manifold 300. For example, an inlet end of the fluid line 380 may be coupled with an outlet of the fluid source and an inlet end of the fluid line 380 may be coupled with the chemical inlet 330. The first portion 316 may be partially and/or fully defined in the first body portion 305 and/or partially and/or fully defined in the second body portion 310. A second portion 317 of each of the plurality of fluid inlet lumens 315 may be defined in the second body portion 310. The plurality of fluid switches 335 may fluidly isolate the first portion 316 from the second portion 317 when the fluid switch 335 is in a closed position. For example, a switch inlet 335A may be inserted within and/or otherwise fluidly coupled with the first portion 316, and a switch outlet 335B may be inserted within and/or otherwise fluidly coupled with the second portion 317. Opening of the fluid switch 335 may enable fluid to pass through the fluid switch 335 and into the second portion 317 as illustrated in FIG. 3B. A third portion 318 of each of the plurality of fluid inlet lumens 315 may be defined in the first body portion 305, the second body portion 310, or a combination of both. For example, a groove may be formed in the upper surface of the first body portion 305 and/or a lower surface of the second body portion 310. When the first body portion 305 and second body portion 310 are joined, the groove(s) may be closed to form the third portion 318. In other embodiments, the third portion 318 of the plurality of fluid inlet lumens 315 may be entirely defined in either the first body portion 305 or the second body portion 310. The first portion 316 may be in fluid communication with the second portion 317, the second portion 317 may be in fluid communication with the third portion 318, and the third portion 318 may be in fluid communication with the fluid outlet lumen to create a flow path that fluidly couples the fluid line 380 and fluid source with the fluid outlet lumen and the flow cell.

The fluid manifold 300 may include a sealable component 340, which may be or include a gasket, an O-ring, or any other sealable component, disposed between the first body portion 305 and the second body portion 310. The sealable component 340 may be operable to provide a fluid-tight seal between the first body portion 305 and the second body portion 310 such that any fluid in the plurality of fluid inlet lumens 315 or fluid outlet lumen does not leak or escape the lumen or body of the fluid manifold 300.

As shown in FIG. 3A, when the fluid switch 335 is closed, the fluid, or reagent, may not flow past the fluid switch 335 or from the first portion 316 to the second portion 317. When the fluid switch 335 is opened, as shown in FIG. 3B, the fluid, or reagent, may flow past the fluid switch 335 or from the first portion 316 to the second portion 317. After flowing to the second portion 317, the fluid, or reagent, may flow to the third portion 318 and then to the fluid outlet lumen, which may deliver the fluid to the flow cell, such as via a fluid delivery conduit as described above.

While not shown in the drawings, the systems and fluid manifolds may include various sensors. The various sensors may be positioned throughout and for example may include, but are not limited to, flow sensors, pressure sensors, temperature sensors, or bubble sensors. The sensors may monitor the conditions of fluids flowing through the fluid manifold and into the flow cell.

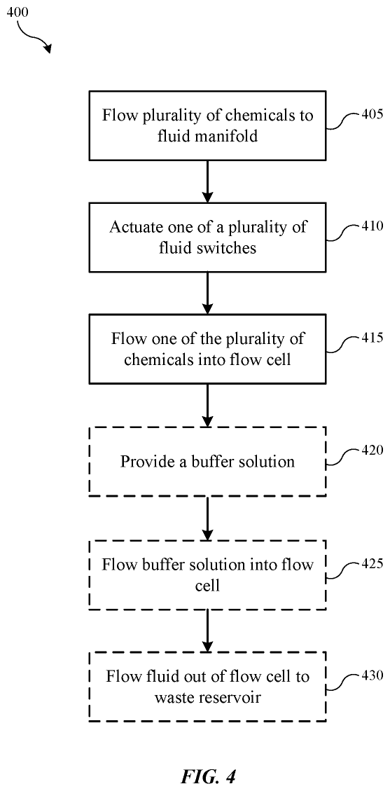

FIG. 4 shows operations of an exemplary method 400 of supplying a chemical to a flow cell according to some embodiments of the present technology. The method may be performed using a variety of flow-cells, including flow cell 150. The method may be performed using a variety of fluid manifolds, including the fluid manifolds 110, 200, or 300 described above. Method 400 may include a number of optional operations, which may or may not be specifically associated with some embodiments of methods according to the present technology.

Method 400 may include operations performed in different orders than illustrated. At operation 405, the method 400 may include flowing a plurality of chemicals to a plurality of chemical inlets of a fluid manifold. The chemicals may include reagents, buffering agents, rinsing agents, and/or other fluids. As described above, the fluid manifold may include a plurality of fluid switches in fluid communication with the plurality of chemical inlets. At operation 410, the method 400 may include actuating one of the plurality of fluid switches to permit one of the plurality of chemicals into a fluid outlet lumen. At operation 415, the method 400 may include flowing the one of plurality of chemicals into the flow cell.

Flowing the one of plurality of chemicals into the flow cell may include flowing the one of plurality of chemicals through a fluid delivery conduit between the fluid manifold and the flow cell. A length of the fluid delivery conduit may be less than or about 2.0 m, such as less than or about 1.8 m, less than or about 1.6 m, less than or about 1.4 m, less than or about 1.2 m, less than or about 1.0 m, less than or about 0.8 m, less than or about 0.6 m, less than or about 0.4 m, or less.

In some embodiments, the method 400 may optionally include sequentially supplying multiple of the plurality of chemicals to the flow cell. In such embodiments, the method 400 may include, subsequent to flowing the one of plurality of chemicals into the flow cell, providing a buffer solution to the fluid outlet lumen at operation 420. The buffer solution may not react with the plurality of chemicals and may serve to purge the fluid outlet lumen of the fluid manifold such that the various chemicals do not undesirably combine or react prior to reaching the flow cell. After the buffer solution is provided to the fluid outlet lumen, the buffer solution may be flowed into the flow cell at operation 425.

In some embodiments, the method 400 may optionally include flowing fluid out of the flow cell to a waste reservoir using a waste lumen defined in the fluid manifold at operation 430. For example, the fluid may be pumped out of the flow cell via a fluid outlet of the flow cell. A rinsing agent may be flowed through the flow cell to rinse any sample to remove any remaining reagent. An additional reagent may then be flowed into the fluid region via the fluid inlet and the tissue sample may be imaged an additional time. Such a process may be repeated any number of times for different reagents to enable the tissue sample to be imaged under different conditions.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a flow cell” includes a plurality of such flow cells, and reference to “the fluid outlet” includes reference to one or more fluid outlets and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A spatial genomics system, comprising:
a flow cell defining an open interior, a fluid inlet in fluid communication with a first end of the open interior, and a fluid outlet that is in fluid communication with a second end of the open interior opposite the first end; and
a fluid manifold comprising a body defining a plurality of fluid inlet lumens, a fluid outlet lumen, and a fluid waste lumen, wherein:
each of the plurality of fluid inlet lumens is fluidly coupled with the fluid outlet lumen;
the fluid outlet lumen is fluidly coupled with the fluid inlet of the flow cell;
the fluid manifold comprises a plurality of fluid switches, each of the plurality of fluid switches being fluidly coupled with a respective one of the plurality of fluid inlet lumens; and
the fluid waste lumen is fluidly coupled with the fluid outlet of the flow cell.

2. The spatial genomics system of claim 1, wherein:
the body of the fluid manifold comprises a first body portion defining at least a portion of each of the plurality of fluid inlet lumens and a second body portion that is interfaced with each of the plurality of fluid switches.

3. The spatial genomics system of claim 2, wherein:
each of the plurality of fluid inlet lumens comprises a section that is formed by a groove defined in a surface of the first body portion that faces the second body portion.

4. The spatial genomics system of claim 1, further comprising:
a first fluid delivery conduit that extends between and couples the fluid outlet lumen of the fluid manifold and the fluid inlet of the flow cell; and
a second fluid delivery conduit that extends between and couples the fluid outlet of the flow cell and the fluid waste lumen.

5. The spatial genomics system of claim 1, further comprising:
a plurality of fluid lines, wherein each fluid line comprises an outlet that is fluidly coupled with a respective fluid source and one of the plurality of fluid inlet lumens.

6. The spatial genomics system of claim 5, wherein:
a medial portion of each of the plurality of fluid inlet lumens defines a fluid outlet port and a fluid inlet port; and
each of the plurality of fluid switches comprises a switch inlet that is interfaced with a respective one of the fluid outlet ports, a switch outlet that is interfaced with a respective one of the fluid inlet ports, and a valve that is movable between an open position and a closed position to control flow through the fluid switch.

7. The spatial genomics system of claim 6, further comprising:
each of the switch inlets is in vertical alignment with a respective outlet of one of the plurality of fluid lines.

8. The spatial genomics system of claim 1, wherein:
the body of the fluid manifold defines a buffer fluid lumen upstream and in fluid communication with the fluid outlet lumen.

9. The spatial genomics system of claim 1, wherein:
the fluid manifold comprises a waste reservoir coupled with an outlet end of the fluid waste lumen.

10. A fluid manifold, comprising:
a body defining a plurality of fluid inlet lumens, a fluid outlet lumen, and a fluid waste lumen, wherein:
each of the plurality of fluid inlet lumens is fluidly coupled with the fluid outlet lumen; and
the fluid outlet lumen comprises an outlet interface; and
a plurality of fluid switches, each of the plurality of fluid switches being fluidly coupled with a respective one of the plurality of fluid inlet lumens.

11. The fluid manifold of claim 10, wherein:
each of the plurality of fluid inlet lumens comprises a first portion that is coupled with a switch inlet of one of the plurality of fluid switches and a second portion that is coupled with a switch outlet of the one of the plurality of fluid switches.

12. The fluid manifold of claim 10, wherein:
the body of the fluid manifold defines a buffer fluid lumen upstream of and in fluid communication with the fluid outlet lumen, the fluid manifold further comprising a buffer fluid switch that is operable to control a flow of buffer fluid through the buffer fluid lumen.

13. The fluid manifold of claim 10, wherein:
each of the plurality of fluid switches comprises a microfluidic flow switch.

14. The fluid manifold of claim 10, wherein:
each of the plurality of fluid inlet lumens comprises a chemical inlet.

15. The fluid manifold of claim 10, wherein:
a portion of each fluid inlet lumen that is upstream of a respective one of the plurality of fluid switches is fluidly isolated from others of the plurality of fluid inlet lumens.

16. A method of supplying a chemical to a flow cell, comprising:
flowing a plurality of chemicals to a plurality of chemical inlets of a fluid manifold, the fluid manifold comprising a plurality of fluid switches in fluid communication with the plurality of chemical inlets;
actuating one of the plurality of fluid switches to permit one of the plurality of chemicals into a fluid outlet lumen; and
flowing the one of the plurality of chemicals into the flow cell.

17. The method of supplying a chemical to a flow cell of claim 16, further comprising:
subsequent to flowing the one of a plurality of chemicals into the flow cell, flowing a buffer solution to the fluid outlet lumen; and
flowing the buffer solution into the flow cell.

18. The method of supplying a chemical to a flow cell of claim 16, further comprising:
flowing fluid out of the flow cell to a waste reservoir using a waste lumen defined in the fluid manifold.

19. The method of supplying a chemical to a flow cell of claim 16, wherein:
flowing the one of a plurality of chemicals into the flow cell comprises flowing the one of plurality of chemicals through a fluid delivery conduit between the fluid manifold and the flow cell, wherein a length of the fluid delivery conduit is less than or about 2.0 m.

20. The method of supplying a chemical to a flow cell of claim 16 further comprising:
sequentially delivering individual chemicals of the plurality of chemicals through respective ones of the fluid switches into the fluid outlet lumen, followed by delivering a buffer solution to the fluid outlet lumen between delivery of each individual chemical of the plurality of chemicals.
